(19) United States
(12) Patent Application Publication
(10) Pub. No.: US 2010/0167710 A1
(43) Pub. Date: Jul. 1, 2010

(54) Telephone call handling

(75) Inventor: Arto Juhani Alhainen, Oulu (FI)

Correspondence Address: HARRINGTON & SMITH, 4 RESEARCH DRIVE, Suite 202, SHELTON, CT, 06484-6212, US

(73) Assignee: Nokia Corporation

(21) Appl. No.: 12/319,064

(22) Filed: Dec. 30, 2008

(51) Int. Cl. H04M 3/56; H04W 4/00

(52) U.S. Cl. 455/416; 379/206.01; 715/810

(57) ABSTRACT

Disclosed herein is an apparatus. The apparatus includes a user input region. The apparatus is configured to move a first icon displayed on the apparatus in response to a received input at the user input region. The apparatus is configured to assign the first icon to a first personal contact. The apparatus is configured to assign a second icon to a second personal contact. The apparatus is configured to initiate a conference call between the first personal contact and the second personal contact in response to a movement of the first icon onto the second icon.

### BACKGROUND

1. Field of the Invention

The invention relates to an electronic device and, more particularly, to telephone call handling for an electronic device.

2. Brief Description of Prior Developments

Although the size of display screens in electronic devices have become larger in recent years, due to the added functionality of these devices, the display screen areas tend become crowded with various icons, shortcuts, and/or other graphical user interfaces. Additionally, the demand for continuous device size miniaturization generates challenges to implement added display screen area.

Further display screen limitations are generated with devices capable of handing multiple telephone calls, such as conference calls for example. These limitations may arise as multiple graphics corresponding to the different calls are shown in the display screen (which adds to the crowding of the display). Accordingly there is a need to provide an improved telephone call handling configuration for an electronic device.

### SUMMARY

In accordance with one aspect of the invention, an apparatus is disclosed. The apparatus includes a user input region. The apparatus is configured to move a first icon displayed on the apparatus in response to a received input at the user input region. The apparatus is configured to assign the first icon to a first personal contact. The apparatus is configured to assign a second icon to a second personal contact. The apparatus is configured to initiate a conference call between the first personal contact and the second personal contact in response to a movement of the first icon onto the second icon.

In accordance with another aspect of the invention, a method is disclosed. A first icon at a first location on a display of a device is selected. The first icon corresponds to a first personal contact. The first icon is moved from the first location onto a second icon. The second icon corresponds to a second personal contact. The second icon is located at a second different location on the display. The first personal contact and the second personal contact are placed in a conference call in response to the moving of the first icon onto the second icon.

In accordance with another aspect of the invention, a method is disclosed. A display is provided. The display is configured to display a first movable icon and a second movable icon. A processor configured to assign the first movable icon to a first personal contact is provided. The processor is configured to assign the second movable icon to a second personal contact. The processor is configured to initiate a conference call between the first personal contact and the second personal contact in response to a movement of only the first icon or only the second icon.

In accordance with another aspect of the invention, a program storage device readable by a machine, tangibly embodying a program of instructions executable by the machine for performing operations to start a conference call is disclosed. A first icon is assigned to a first personal contact. The first icon is movable within a display portion of a device. A second icon is assigned to a second personal contact. The second icon is movable within the display portion of the device. A conference call is initiated between the first personal contact and the second personal contact in response to a movement of the first icon onto the second icon.

### BRIEF DESCRIPTION OF THE DRAWINGS

The foregoing aspects and other features of the invention are explained in the following description, taken in connection with the accompanying drawings, wherein:

FIG. 1 is a perspective view of an electronic device incorporating features of the invention;

FIG. 2 is a view of a display of the device shown in FIG. 1;

FIG. 3 is another view of the display of the device shown in FIG. 1 with two icons displayed;

FIG. 4 is another view of the display of the device shown in FIG. 1 with the two icons displayed in a different configuration;

FIG. 5 is another view of the display of the device shown in FIG. 1 with a drag operation in progress displayed;

FIG. 6 is another view of the display of the device shown in FIG. 1 with a conference icon displayed;

FIG. 7 is another view of the display of the device shown in FIG. 1 with a third icon displayed;

FIG. 8 is a partial view of a device in accordance with another embodiment of the invention;

FIG. 9 is a block diagram of an exemplary method of the device shown in FIGS. 1, 8;

FIG. 10 is a block diagram of another exemplary method of the device shown in FIGS. 1, 8; and

FIG. 11 is a schematic drawing illustrating components of the device shown in FIGS. 1, 8.

### DETAILED DESCRIPTION

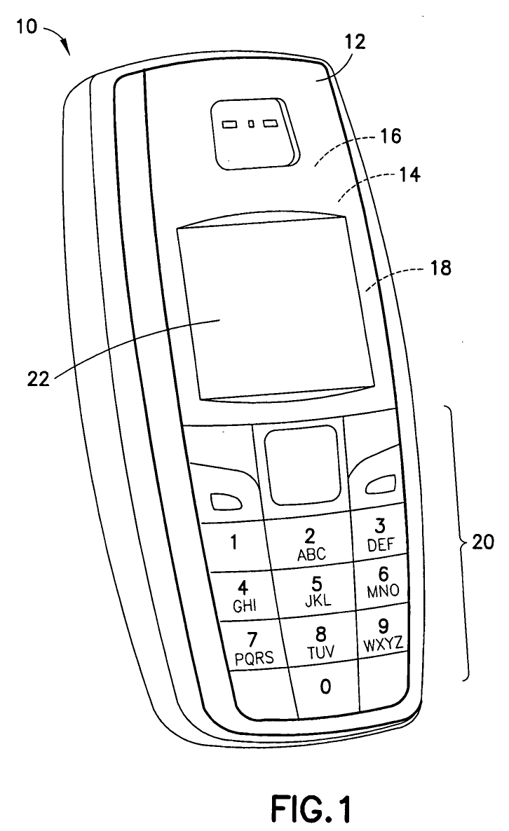

Referring to FIG. 1, there is shown a perspective view of an electronic device 10 incorporating features of the invention. Although the invention will be described with reference to the exemplary embodiments shown in the drawings, it should be understood that the invention can be embodied in many alternate forms of embodiments. In addition, any suitable size, shape or type of elements or materials could be used.

According to one example of the invention, the device 10 is a multi-function portable electronic device. However, in alternate embodiments, features of the various embodiments of the invention could be used in any suitable type of portable electronic device such as a mobile phone, a gaming device, a music player, a notebook computer, or a PDA, for example. In addition, as is known in the art, the device 10 can include multiple features or applications such as a camera, a music player, a game player, or an Internet browser, for example. The device 10 generally comprises a housing 12, a transceiver 14 connected to an antenna 16, electronic circuitry 18, such as a controller and a memory for example, within the housing 12, a user input region 20 and a display 22. The display 22 could also form a user input section, such as a touch screen. It should be noted that in alternate embodiments, the device 10 can have any suitable type of features as known in the art.

The touch screen display 22 may comprise any suitable configuration for detecting a contact, a touch, and/or a movement on the display 22. For example the touch screen display may comprise a sensor and/or a sensor system configured to receive input from the user. The sensor (or the sensor system), may, for example, comprise touch sensors and/or proximity sensors. The sensor(s) may comprise capacitive, resistive, acoustic, and/or optical configurations. However, any suitable type of sensor (or sensor system) having touch and/or proximity sensing capability may be provided.

Various embodiments of the invention provide an improved device configuration for users to perform dragging and dropping operations on the touch screen display to initiate (or add callers to) a conference call.

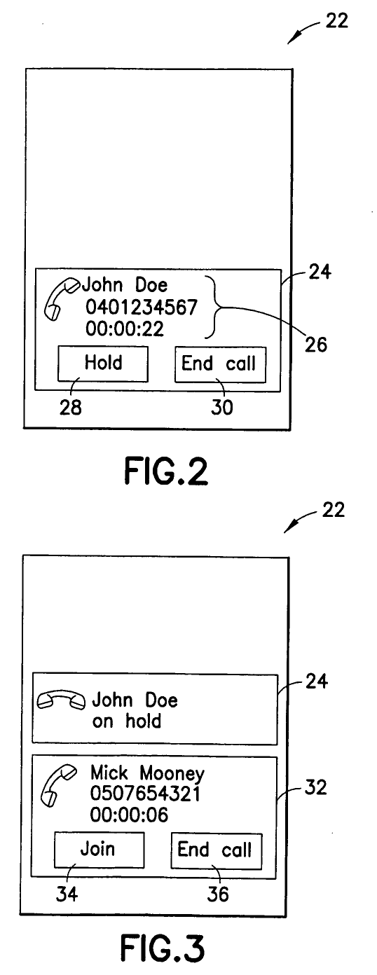

For example, referring now also to FIG. 2, an icon 24 may be displayed on the touch screen user interface 22. The icon 24 may be assigned to a personal contact. The personal contact may be for example, a caller on a call line of the device 10. The caller may be a person who placed a call to the device 10 or a person to whom a call was placed to (from the device 10). The icon 24 may display information 26 corresponding to the personal contact, such as a name of the contact, a phone number of the contact, and/or a call duration (for example, “John Doe”, “0401234567”, and “00:00:22” as shown in FIG. 2). However, any suitable information corresponding to the caller may be provided. A portion (or all) of the information 26 may be provided from a caller identification (caller ID) or a caller line identification (CLI) system for example. The information corresponding to the caller may also be provided by personal contact information stored in a memory of the device. However, it should be noted that the display information corresponding to connected call line may be provided by any suitable method. It should further be understood that the personal contact may be any other connected call line to the device, such as a caller not having personal contact information stored in the device, a first time caller to the device, a first time recipient of a call from the device, or a random caller to/from the device, for example.

Additionally, the icon 24 may comprise touch buttons 28, 30. The touch buttons 28, 30 may be buttons or keys displayed within the icon 24 for placing the contact on/off hold (“Hold” or “Unhold” button 28), ending a call with the contact (“End call” button 30), or joining two or more calls together (“Join” button) for forming a conference call, for example. However, these are merely examples, and other touch buttons for any suitable call operation may be provided.

It should be understood that the icons described above and throughout the specification may be a small window or bubble viewable on the display comprising caller information (such as a name or a telephone number, for example). However, any suitable graphic, image, or illustration corresponding to a caller may be provided.

According to some embodiments of the invention, touch buttons may be displayed in one icon (or call bubble) at a time (such as in multi-call cases) while the other icon(s) is minimized. For example, as shown in FIG. 3, a multi-call case is illustrated wherein the call line (“John Doe”) corresponding to the icon 24 and another connected call line (“Mick Mooney”, corresponding to icon, or call bubble, 32) on the device 10 are displayed on the display 22. When the icon 32 is maximized (or open), call buttons 34, 36 are viewable within the icon 32, while the call bubble 24 is minimized (or preshrunked) with the touch buttons 28, 30 hidden from view. In this example, the call status (such as “on hold”) may be displayed within the minimized bubble 24. However, any other suitable information may be displayed, such as caller ID/CLI information for example).

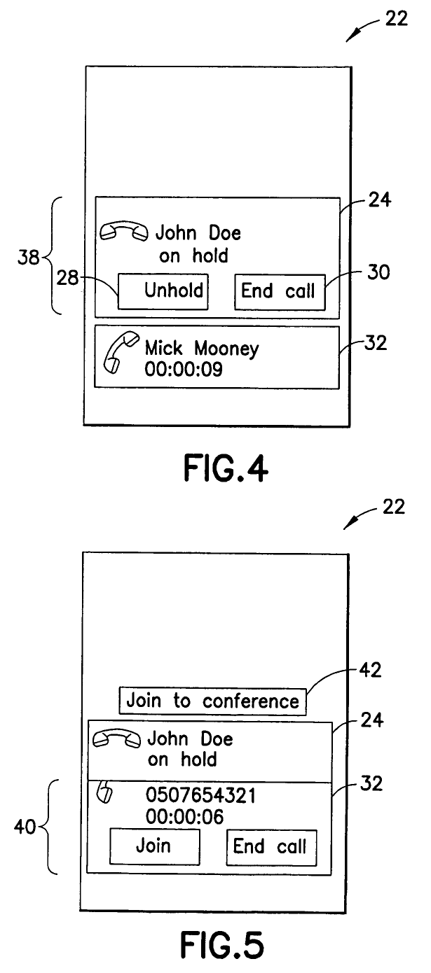

By tapping (or clicking) on a minimized bubble, the user may ‘open’ (or maximize) the bubble. According to some embodiments, this may provide for an automatic change in the configuration of the icons. For example as shown in FIGS. 3 and 4, a user of the device may perform a touch screen operation (such as a touch or a click on the touch screen 22, for example) on the icon 24 to maximize the icon 24. When the icon 24 is maximized (see FIG. 4), the buttons 28, 30 may appear within the icon. At the same time that the icon 24 is maximized, the icon 32 automatically minimizes (see FIG. 4) wherein the buttons 34, 36 disappear (or are hidden) from the icon 32 (after a touch on the maximized icon 32 shown in FIG. 3). However, any suitable automatic (or manual) size configuration may be provided in response to touch screen operations.

Referring now also to FIG. 5, when the user of the device performs a drag operation on (or drags) the icon 24 on to the icon 32, the calls may be joined as a conference call. For example, the user may drag the icon 24 from a first location 38 (see FIG. 4) to a second location 40 (see FIG. 5), wherein the second location is proximate the icon 32. Dragging and dropping the icon 24 on to the icon 32 provides for a conference call to be initiated between the two call lines (“John Doe” and “Mick Mooney”).

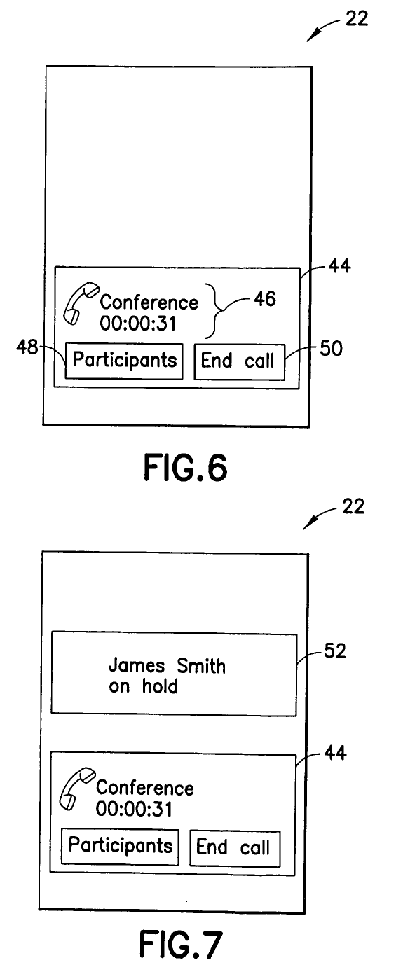

According to some embodiments of the invention, when the icons 24, 32 are close enough one upon each other (such as when the icon 24 is being dragged in a direction proximate the second area 40 or the icon 32, for example), a tooltip, or small window, 42 may be provided. The tooltip may display a message such as “join to conference”, for example. Once the icon 24 is over the icon 32, the user can perform a drop operation (or drop) the icon 24 and the calls are then joined in a conference call (see FIG. 6). According to some embodiments of the invention, after the icon 24 is dropped onto the icon 32, a single “Conference” icon 44 is displayed. Similar to the icons 24, 32, the icon 44 may comprise display information 46, and touch buttons 48, 50. However, any suitable icon configuration may be provided.

It is to be understood that although the tooltip described above displays the message “Join to conference”, any suitable message may be displayed. Additionally, it should further be noted that the some embodiments of the invention may provide for the dragging and dropping operation without providing a small window or graphic (as one icon approaches another icon), as tooltip 42 is not required.

It should also be noted that although the description above provides for the icon 24 to be dragged and dropped on the icon 32 for a conference call between the two to be initiated, any suitable order of dragging and dropping may be provided. For example, the icon 32 may be dragged and dropped onto the icon 24 to initiate a conference call. However, any drag and drop operations may be provided between suitable icons for initiating conference calls. Additionally, drag and drop operations for the moving the icons over one another are not required. According to various embodiments of the invention, any suitable operation(s) capable of moving the icons may be provided for initiating the conference call.

According to various exemplary embodiments of the invention, more contacts may be added to the conference call. For example, a third contact (“James Smith”) corresponding to the icon 52 (see FIG. 7) may be added to the conference call 44. As described above, the user of the device may drag the icon, or window, 52 over the conference icon 44 to place “James Smith” in the conference call. Additionally, any number of icons may be dropped onto the conference icon to add callers for participation in the conference call.

It should be understood that any suitable device configuration(s) for assigning call lines to icons, moving icons, initiating calls or conference calls, etc., may be provided. For example, according to some embodiments of the invention, a processor of the device may be configured to assign an icon to a personal contact. The processor may also be configured to initiate the conference call between the contacts 9 or call lines) in response to the movement of the icons (such as dragging and dropping one icon onto another icon). However, any suitable device operations may be provided.

It should be noted that the touchscreen operations (such as drag and drop) may be provided in any suitable manner such as, touchscreen operations between the user's finger and the touch screen, or touchscreen operations between a pen or stylus of a device and the touchscreen, for example. However, any suitable touchscreen operation may be utilized. It should further be noted that in some embodiments, a touch screen may not be provided at all. For example, selection, drag, and drop operations may be provided with keyboard key operations and/or rocker keys, operations for example.

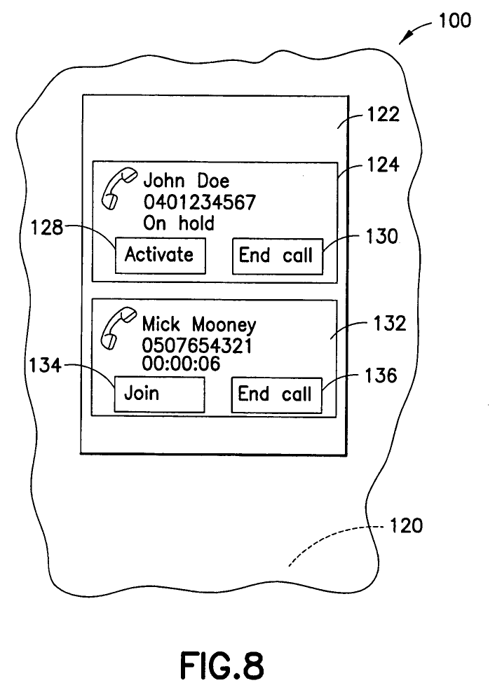

Referring now also to FIG. 8, a device 100 according to another embodiment of the invention is shown. The device 100 is similar to the device 10 and comprises a user input region 120 and a touchscreen display 122. The device 100 is configured, in a similar fashion as described above for the device 10, to initiate conference calls between call lines of the device by performing drag and drop operations (such as dragging one icon onto another icon) on the touchscreen user interface 122. However, one difference between the device 100 and the device 10 is that the device 100 displays the icons 124, 132 in a maximized view simultaneously. This allows for viewing the touch buttons 128, 130, 134, 136 without minimizing and maximizing the respective icons. However, any suitable display orientation for the icons 124, 132 may be provided. As described above for the device 10, the icons 124, 132 may be moved on top of one another to initiate a conference call between the two call lines (corresponding to “John Doe” and “Mick Mooney”).

Various exemplary embodiments of the invention provide a method for adding an additional member to an ongoing call wherein a touch sensitive screen of a phone displays a bubble representative of the ongoing call. The system displays a second bubble representative of a second call. The second call may be conferenced with the ongoing call by dragging and dropping the second bubble representative of the second call over the bubble of the ongoing call. The system may utilize the touch sensitive properties of the device to enable the drag and drop of bubbles.

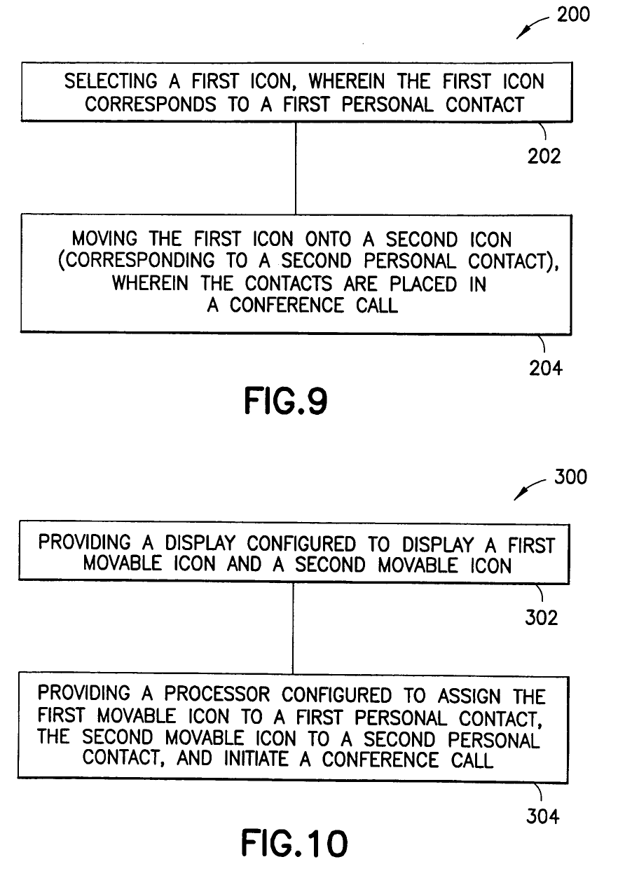

FIG. 9 illustrates a method 200. The method 200 includes the following steps. Selecting a first icon at a first location on a display of a device. The first icon corresponds to a first personal contact (step 202). Moving the first icon from the first location onto a second icon. The second icon corresponds to a second personal contact. The second icon is located at a second different location on the display. The first personal contact and the second personal contact are placed in a conference call in response to the moving of the first icon onto the second icon (step 204). It should be noted that any of the above steps may be performed alone or in combination with one or more of the steps.

FIG. 10 illustrates a method 300. The method 300 includes the following steps. Providing a display. The display is configured to display a first movable icon and a second movable icon (step 302). Providing a processor configured to assign the first movable icon to a first personal contact. The processor is configured to assign the second movable icon to a second personal contact. The processor is configured to initiate a conference call between the first personal contact and the second personal contact in response to a movement of only the first icon or only the second icon (step 304). It should be noted that any of the above steps may be performed alone or in combination with one or more of the steps.

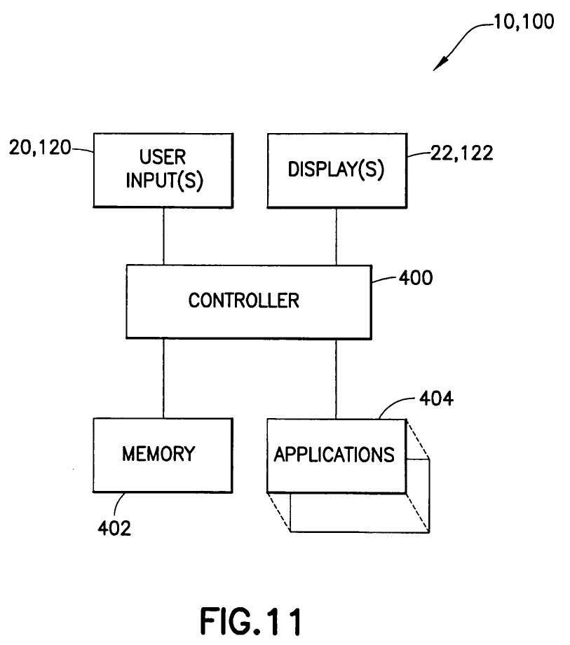

Referring now also to FIG. 11, the device 10, 100 generally comprises a controller 400 such as a microprocessor for example. The electronic circuitry includes a memory 402 coupled to the controller 400, such as on a printed circuit board for example. The memory could include multiple memories including removable memory modules for example. The device has applications 404, such as software, which the user can use. The applications can include, for example, a telephone application, an Internet browsing application, a game playing application, a digital camera application, a map/gps application, etc. These are only some examples and should not be considered as limiting. One or more user inputs 20, 120 are coupled to the controller 400 and one or more displays 22, 122 are coupled to the controller 400. The device 10, 100 may programmed to automatically initiate conference calls. However, in an alternate embodiment, this might not be automatic. The user may actively start the conference calls.

Technical effects of any one or more of the exemplary embodiments provide for improved configurations when compared to conventional devices. For example, conventional configurations tend to provide crowded display screens during multi-call handling operations. This results from numerous icons or windows displayed in the display. Various exemplary embodiments of the invention provide for improved multi-call handling configurations by minimizing the number of icons or windows displayed in the display when initiating a conference call (such as when initiating a conference call between a first personal contact and a second personal contact in response to a movement of only a first icon or a second icon (onto the other of the first icon or the second icon). This may, for example, provide for easier initiation of conference calls (and adding callers to an ongoing call) and further may save space on the display screen (which may be used for other call lines, or other applications).

According to one example of the invention, an apparatus is disclosed. The apparatus includes a user input region. The apparatus is configured to move a first icon displayed on the apparatus in response to a received input at the user input region. The apparatus is configured to assign the first icon to a first personal contact. The apparatus is configured to assign a second icon to a second personal contact. The apparatus is configured to initiate a conference call between the first personal contact and the second personal contact in response to a movement of the first icon onto the second icon.

According to another example of the invention, a program storage device readable by a machine, tangibly embodying a program of instructions executable by the machine for performing operations to start a conference call is disclosed. A first icon is assigned to a first personal contact. The first icon is movable within a display portion of a device. A second icon is assigned to a second personal contact. The second icon is movable within the display portion of the device. A conference call is initiated between the first personal contact and the second personal contact in response to a movement of the first icon onto the second icon.

It should be understood that components of the invention can be operationally coupled or connected and that any number or combination of intervening elements can exist (including no intervening elements). The connections can be direct or indirect and additionally there can merely be a functional relationship between components.

It should be understood that the foregoing description is only illustrative of the invention. Various alternatives and modifications can be devised by those skilled in the art without departing from the invention. Accordingly, the invention is intended to embrace all such alternatives, modifications and variances which fall within the scope of the appended claims.

1. An apparatus comprising a user input region wherein the apparatus is configured to move a first icon displayed on the apparatus in response to a received input at the user input region, wherein the apparatus is configured to assign the first icon to a first personal contact, wherein the apparatus is configured to assign a second icon to a second personal contact, and wherein the apparatus is configured to initiate a conference call between the first personal contact and the second personal contact in response to a movement of the first icon onto the second icon.

2. An apparatus as in claim 1 wherein the apparatus is configured to move the first icon and/or the second icon displayed on the apparatus in response to the received input at the user input region, and wherein the apparatus is configured to initiate the conference call between the first personal contact and the second personal contact in response to a movement of the first or the second icon onto the other of the first or the second icon.

3. An apparatus as in claim 1 wherein the apparatus further comprises a processor, wherein the processor is configured to assign the first icon to the first personal contact, wherein the processor is configured to assign the second icon to the second personal contact, and wherein the processor is configured to initiate the conference call between the first personal contact and the second personal contact in response to the movement of the first icon onto the second icon.

4. An apparatus as in claim 1 wherein the user input region comprises a touch screen user interface.

5. An apparatus as in claim 1 wherein the apparatus is configured to assign a third icon to a third personal contact, and wherein the apparatus is configured to initiate a conference call between the first personal contact, the second personal contact, and the third personal contact in response to a movement of the third icon onto the second icon.

6. An apparatus as in claim 1 wherein the apparatus is a mobile electronic device.

7. A method comprising:
selecting a first icon at a first location on a display of a device, wherein the first icon corresponds to a first personal contact; and
moving the first icon from the first location onto a second icon, wherein the second icon corresponds to a second personal contact, wherein the second icon is located at a second different location on the display, and wherein the first personal contact and the second personal contact are placed in a conference call in response to the moving of the first icon onto the second icon.

8. A method as in claim 7 wherein the moving of the first icon from the first location onto the second icon further comprises dragging the first icon over the second icon and dropping the first icon onto the second icon.

9. A method as in claim 7 wherein the first icon corresponds to the first personal contact connected to a first call line, and wherein the second icon corresponds to the second personal contact connected to a second call line.

10. A method as in claim 7 wherein the selecting of the first icon at the first location on the display of the device further comprises sensing a touch at the first location on a touch screen user interface.

11. A method as in claim 7 further comprising:
selecting a third icon on the display of the device, wherein the third icon corresponds to a third personal contact; and
moving the third icon onto the second icon, wherein the third personal contact is placed in the conference call with the first personal contact and the second personal contact in response to the moving of the third icon onto the second icon.

12. A method comprising:
providing a display, wherein the display is configured to display a first movable icon and a second movable icon; and
providing a processor configured to assign the first movable icon to a first personal contact, wherein the processor is configured to assign the second movable icon to a second personal contact, and wherein the processor is configured to initiate a conference call between the first personal contact and the second personal contact in response to a movement of only the first icon or only the second icon.

13. A method as in claim 12 wherein the movement of only the first icon or only the second icon further comprises dragging and dropping the first or the second icon onto the other of the first or the second icon.

14. A method as in claim 12 wherein the providing of the display further comprises providing a touch screen user interface.

15. A method as in claim 12 wherein the display and the processor are provided at a housing of a portable electronic device.

16. A program storage device readable by a machine, tangibly embodying a program of instructions executable by the machine for performing operations to start a conference call, the operations comprising:
assigning a first icon to a first personal contact, wherein the first icon is movable within a display portion of a device;
assigning a second icon to a second personal contact, wherein the second icon is movable within the display portion of the device; and
initiating a conference call between the first personal contact and the second personal contact in response to a movement of the first icon onto the second icon.

17. A program storage device as in claim 16 wherein the first icon corresponds to the first personal contact connected to a first call line, and wherein the second icon corresponds to the second personal contact connected to a second call line.

18. A program storage device as in claim 16 wherein initiating of the conference call further comprises initiating the conference call in response to a movement of the first or the second icon onto the other of the first or the second icon.

19. A program storage device as in claim 16 wherein the initiating of the conference call further comprises sensing a touch at the first icon on a touch screen user interface of the device.

20. A program storage device as in claim 16 further comprising:
assigning a third icon to a third personal contact, wherein the third icon is movable within the display portion of the device; and
initiating a conference call between the first personal contact, the second personal contact, and the third personal contact in response to a movement of the third icon onto the second icon.
